(19) United States
(12) Patent Application Publication
(10) Pub. No.: US 2015/0321693 A1
(43) Pub. Date: Nov. 12, 2015

(54) Steering Arrangement

(71) Applicant: SAF-HOLLAND, GmbH, Bessenbach (DE)

(72) Inventors: Josef Büttner, Waldaschaff (DE); Lutz Böhme, Sailauf (DE)

(21) Appl. No.: 14/405,656

(22) PCT Filed: May 31, 2013
(86) PCT No.: PCT/EP2013/061226

§ 371 Date: Dec. 4, 2014

(30) Foreign Application Priority Data
Jun. 11, 2012 (DE) 10 2012 209 690.6

(51) Int. Cl. B62D 5/18; B62D 5/08; B62D 5/06; B62D 5/12

(52) U.S. Cl. CPC B62D 5/18; B62D 5/12; B62D 5/08; B62D 5/062

(57) ABSTRACT

The present invention relates to a steering arrangement, a restoring part and a steering system, that includes a tie bar unit, an actuating unit and a lever element, the lever element being fixed in a pivotable manner at a first turning point immovably disposed in a reference system, wherein the actuating unit has a restoring part, an active part and a damping part and is secured against displacement along a transverse axis relative to the reference system, at least one of the parts exerting a force on the tie rod unit to displace the tie rod unit along the transverse axis or to secure it against displacement, wherein the tie rod unit is pivotably fixed at a second turning point on the lever element and therefore displacement of the tie rod unit along the transverse axis leads to a pivoting movement of the lever element about the first turning point.

### BACKGROUND OF THE INVENTION

The present invention relates to a steering arrangement, a restoring part and a steering system, particularly for commercial vehicles or utility vehicles.

Steering arrangements, particularly for use in commercial vehicles and trailers thereof, are well known in the prior art. Here, for example, an arrangement, on which the wheel of the commercial vehicle can be mounted and which is pivotable relative to the vehicle frame, is displaced by a tie rod transverse to the longitudinal axis of the vehicle such that the attached wheel carries out a pivoting movement. Furthermore, it is known in the prior art to provide a stabilizing unit, which damps vibrations of the steering arrangement and restores the steering arrangement to a neutral position, in which the commercial vehicle moves straightforward or in which the wheels rotate about an axis running perpendicular to the longitudinal axis of the vehicle. It is further known to supplement the force applied by the tie rod by an additionally arranged hydraulic or pneumatic actuating unit, wherein the actuating unit also ensures a so-called reverse lock or steering lock, i.e. the steering arrangement of the commercial vehicle is fixed in a certain pivot position. A disadvantage of the solutions known from the prior art is that a plurality of units have to be provided on the vehicle axle suspension system in order to ensure the plurality of functions. Negative consequences are a high weight, great space requirements and, due to the large overall contact surface for foreign matter swirled up in the chassis area, a high probability of damage and a reduced service life.

The object underlying the present invention is to provide a steering arrangement and a restoring part, which are as compact and light-weight as is possible and which at the same time fulfill the requirements on steering arrangements known from the prior art.

### SUMMARY OF THE INVENTION

According to the invention, the steering arrangement, particularly for use in commercial vehicles and trailers thereof, comprises a tie rod unit or a tie bar unit, an actuating unit or a force unit and a lever element, the lever element being fixed in a pivotable or swivelable manner at a first turning point immovably disposed or arranged in a reference system, wherein the actuating unit has a restoring part, an active part and a damping part and is secured against displacement along a transverse axis relative to the reference system, at least one of the parts exerting a force on the tie rod unit to displace the tie rod unit along the transverse axis or to secure it against displacement along the transverse axis, wherein the tie rod unit is pivotably fixed at a second turning point on the lever element and therefore displacement of the tie rod unit along the transverse axis leads to a pivoting movement of the lever element about the first turning point. Preferably, the reference system, in relation to the vehicle, i.e. a motor vehicle or a commercial vehicle, is a fixed coordinate system with a transverse axis and a longitudinal axis running perpendicular thereto. The transverse axis runs particularly preferably perpendicular to the straightforward driving direction of the vehicle. Preferably, on the chassis of the vehicle a lever element is pivotably arranged, which preferably is the steering lever of a kingpin steering, which is known as such. Advantageously, the first turning point is located in a journal or bearing, which fixes the lever element on the vehicle frame pivotably and immovably or secured against translation, wherein the pivoting movement of the lever element particularly preferably takes place about a vertical direction essentially perpendicular to the plane spanned by the longitudinal direction of the transverse direction of the reference system. Preferably, the actuating unit is an assembly designed in the shape of a hollow cylinder, which is fixed at least against displacement along the transverse direction relative to the vehicle frame or relative to the reference system. According to the invention, the actuating unit comprises a restoring part, an active part and a damping part, wherein said three parts are in particular characterized by the function realized by them, and each comprise engagement means preferably engaging on the tie rod unit. The restoring part preferably has at least one restoring element, which preferably indirectly or directly transmits a force to the tie rod unit, in order to guide the latter into a position relative to the actuating unit or relative to the reference system, in which the lever element is arranged in a so-called neutral position or straightforward driving position. The straightforward driving position is in particular characterized in that bearing areas preferably provided on the lever element are positioned for rotatably mounting wheels on the lever element essentially along or parallel to the transverse axis. To put it differently, in the neutral position of the lever element, the steering deflection is zero. The restoring element arranged in the restoring part is preferably a spiral spring, which preferably may be subjected to pressure and which, when there is a steering deflection or a movement of the tie rod unit along the transverse axis to the left or to the right in relation to the commercial vehicle, exerts a force on the tie rod unit, which seeks to reset the latter to the neutral position. The active part of the actuating unit preferably serves for controlling the displacement of the tie rod unit relative to the actuating unit. Preferably, in the active part, there is a hydraulic or pneumatic coupling between the actuating unit and a piston provided preferably on the tie rod unit, wherein the actuating unit preferably in front of and behind the piston has supply and discharge channels for supplying and discharging a working fluid. By supplying or discharging a working fluid in the chambers of the actuating unit, which chambers are separated from each other by the piston, the piston is pushed to the left or to the right, in relation to the straightforward driving direction of the commercial vehicle. The functional principle of the active part preferably corresponds to a hydraulic or pneumatic piston system known from the prior art, in which a piston element is arranged in a hollow cylinder shaped component and separates the latter into two fluid sections, wherein by supplying or discharging the fluid in one of the two sections the piston element is displaced within the hollow cylinder shaped component. Alternatively to the hydraulic or pneumatic design of the active part, also a mechanical coupling by means of a tooth element, for example, which is in form-fit or positive engagement with a corresponding gear wheel or worm gear, may be ensured. The damping part of the actuating unit is adapted to cushion vibrations and shocks acting on the steering arrangement and/or the lever element by transmitting a damping force to the tie rod unit. Here, it is preferred that vibrations with a certain frequency, such as those caused by imbalances on the wheels, which cause periodic vibrations and in the case of a resonance may cause a self-oscillation of the entire steering system of the commercial vehicle, are limited to a safety-uncritical maximum. Preferably, the damping part is based on the principle known from the prior art of a hydraulic vibration damper, in which a fluid displaced by a piston element flows through valves or apertures or bores, whereby causing a flow resistance, which converts kinetic energy into thermal energy, and thus delays or damps a displacement of the components, which are movable relative to each other. Preferably, the actuating unit has an inner area and an outer, hollow body shaped area surrounding the inner area, wherein the active part and the damping part preferably are arranged in the inner area and the restoring part is preferably is arranged in the surrounding outer area. An advantage of integrating the active part, the damping part and the restoring part into the actuating unit is the particularly compact design as well as a reduction in weight, since preferably only one housing is required for the individual parts. Further preferably, the area provided on the lever element for mounting a wheel in the straightforward driving direction of the vehicle is arranged behind the first turning point. As is known, this arrangement is also referred to as trailing axle and in particular serves to achieve that the steering arrangement of the commercial vehicle by itself pivots back into the neutral position when the hydraulic system fails or when no controlling force acts on the steering system during the straightforward travel. The cause for this is the rolling resistance of the wheels of the vehicle acting behind the first turning point in relation to the straightforward driving direction, which resistance pivots the steering arrangement back into the neutral position. When the commercial vehicle travels backwards, it is in most cases necessary for the steering arrangement to be provided with a fixing or reverse lock function, which particularly preferably is realized by the active part of the actuating unit. To this end, if the active part is designed as a hydraulic or pneumatic component, the valves used for supplying and discharging the working fluid are closed, wherein the working fluid contained in the active part secures the tie rod unit against displacement along the transverse direction. Particularly preferably, the actuating unit is fixed on a rigid axle or on the rigid part of the steering axle of the vehicle, wherein the reference system in this case is disposed immovably to the rigid axle. Further preferably, at the distal ends of the rigid axle, preferably a respective first turning point is provided, on which a lever element is pivotably fixed.

Preferably, the tie rod unit passes through the actuating unit and is fixed at the respective distal ends thereof in a second turning point at respective lever element. Particularly preferably, the tie rod unit is guided in the actuating unit such that it may be displaced only along its main extension direction relative to the actuating unit. Furthermore, the tie rod unit preferably has various engagement sections, which engage the restoring part and/or the active part and/or the damping part and which transmit forces from each of said parts to the tie rod unit. Since the various functions of the steering unit are combined in the tie rod unit, it is possible to design the steering arrangement as compact as is possible and to save additional weight on the tie rod unit. Here, the tie rod unit carries out both the active steering, i.e. controlling the steering position of the steering arrangement, and the stabilization, i.e. preferably restoring the steering arrangement to the neutral position, and preferably the damping of vibrations occurring on the steering arrangement.

Preferably, the actuating unit is mounted pivotably relative to the reference system, so that displacement components of the second turning point perpendicular to the transverse direction are compensated by pivoting the actuating unit. The displacement components of the second turning point perpendicular to the transverse direction are transmitted via the tie rod unit to the actuating unit. Said displacement components of the second turning point perpendicular to the transverse direction are generated in particular in that the second turning point moves along a circular path. In order to prevent that the suspension of the actuating unit or of the tie rod unit bends or is damaged, it is preferred that the actuating unit is mounted pivotably relative to the reference system. The actuating unit can be mounted pivotably particularly preferably by a ball-and-socket joint or by an arrangement consisting of a bore and an engaging journal, fixed preferably on the chassis or the rigid axle.

It is further preferred that the actuating unit has a fixing element, which fixes the actuating unit perpendicular to the transverse direction movably relative to the reference system. To put it differently, the fixing element, insofar as this is possible ensures that the actuating unit is secured against displacement along the transverse direction. At the same time, however, it allows for a displacement of the actuating unit relative to the reference system perpendicular to the transverse direction. A preferred arrangement of the actuating unit, pivotable and displaceable perpendicular to the transverse direction, makes it possible that in the case of a steering deflection of two lever elements fixed to the tie rod unit, the respective second turning points may be displaced in different directions perpendicular to the transverse direction, wherein the actuating unit guiding the tie rod unit is pivoted in relation to the reference system and displaced relative to the reference system perpendicular to the transverse direction. It has proven to be expedient to secure the actuating unit by means of the fixing region only against displacement along the transverse direction, wherein a pivoting movement and a displacement perpendicular to the transverse direction remain possible. The pivoting movement of the fixing element, and the fixing point moving hence on a circular path between the fixing element and the actuating unit indeed leads to a slight, essentially negligible movement of the actuating unit along the transverse direction, which is taken into account in the layout of the steering arrangement. The definition of the immovability of the actuating unit along the transverse direction therefore neglects merely this point.

In an alternatively preferred embodiment, the tie rod unit has a joint or hinge, which pivotably fixes a first tie rod section and a second tie rod section to each other, wherein the first tie rod section is preferably guided in the actuating unit and secured against displacement transverse or perpendicular to the transverse direction, and wherein the actuating unit is fixed immovably and secured against pivoting relative to the reference system. Alternatively to the arrangement of the actuating unit, which is pivotable or displaceable perpendicular to the transverse direction, it may also be preferred to provide at least one, particularly preferably two joints on the tie rod unit, which pivotably fix one respective second tie rod section to the first tie rod section. Here, the path components, which are caused by a pivoting movement of the lever element perpendicular to the transverse direction, are compensated by pivoting movements of the second tie rod sections relative to the first tie rod section, and the first tie rod section displaces exclusively along the transverse direction, and no pivoting arrangement of the actuating unit is necessary. Particularly preferably, the joint is designed as a ball-and-socket joint, where a ball socket or joint socket preferably provided on the first tie rod section accommodates a joint head or ball section preferably provided on the second tie rod unit and mounts it pivotably. Particularly preferably, in this embodiment, the actuating unit may be fixed immovably on the vehicle axle or the vehicle frame, wherein advantageously further complicated arrangements and components are thus avoided and a high service life and reliability or stability of the steering arrangement are ensured.

Further preferably, the second tie rod section has an extension, which is in a relationship of 0.3-1.5, preferably 0.5-1, and particularly preferably 0.7-0.8 to the maximum displacement path of the tie rod unit along the transverse axis. The larger said relationship, the larger the second tie rod section relative to the maximum displacement path of the tie rod unit along the transverse axis, wherein it is in particular preferred that there is a smaller deflection or a smaller change of angle in the pivoting movement of the second tie rod section to the first tie rod section, and respective force components, which act perpendicular to the transverse axis on the first tie rod section and, thus, on the actuating unit, are reduced. When the extension of the second tie rod section is too large, however, an increased building space requirement or an insufficiently compact design of the steering arrangement may be disadvantageous. It has been shown that steering arrangements having a preferred relationship of 0.3-1.5 of the length of the second tie rod section relative to the maximum displacement of the tie rod unit along the transverse axis reliably fulfill the compactness requirements while at the same time the transverse forces on the tie rod unit or on the first tie rod section are minimized.

Further preferably, the lever element has a lever arm extending between the first and the second turning points, wherein in the neutral position of the lever arm, the straight line running along the lever arm is directed or aligned pivoted at an angle to the transverse direction of the reference system, and wherein the angle is preferably larger than 90°. The non-perpendicular alignment of the lever arm of the lever element in the neutral position preferably serves to create the so-called steering trapezoid. To this end, the straight line running along the lever arm is preferably arranged pivoted at an angle of more than 90° from the transverse axis, opposite the straightforward driving direction of the commercial vehicle, wherein, as a consequence, the respective steering element lying outside in the traveled curve is deflected less from the neutral position than the respective steering element lying inside. To put it differently, the angle has to be spanned from the transverse axis or a parallel to the transverse axis in an arc running opposite the straightforward driving direction up to the straight line, intersecting between the first and the second turning point. For example, in the case of a trailing axle, depending on whether the second turning point is arranged in the straightforward driving direction behind or, in relation to the arrangement in the commercial vehicle, behind the first turning point or vice versa, the angle is in each case defined. In case the second turning point is arranged behind the first turning point in the straightforward driving direction, the angle is measured from the transverse axis or the end opposite the straightforward driving direction of the transverse axis facing outwards in the direction of the preferably provided wheels of the commercial vehicle up to the straight line running along the lever arm. In this case, the shorter one of the two parallels of the steering trapezoid is limited by the first turning points, and the longer one is limited by the second turning points. Preferably, the angle of pivoting of the lever arm relative to the transverse axis is in a range of 91°-160°, particularly preferably 95°-420°, and most preferably it is about 100°-115°. It has been shown that said angle ranges particularly preferably allow for an optimum driving comfort, an optimum driving safety and a reduced wear on the tires for various vehicle lengths or for various distances of the wheel suspension systems provided with a steering arrangement from the wheel suspension systems disposed therebehind or in front thereof.

Preferably, the first turning point is spaced apart from the second turning point by a lever length, wherein the tie rod unit is displaceable within a maximum displacement path along the transverse axis, and wherein the relationship of the lever length to the maximum displacement path is in a range of 0.7-1.3, preferably 0.85 to 1.1, and particularly preferably it is about 0.9-1. The relationship of the lever length to the maximum displacement path of the tie rod unit makes it particularly preferably possible to adjust the possible pivoting range of the lever element. In the case of a small relationship of the lever length to the maximum displacement path, a small pivoting range of the lever element for a given displacement path of the tie rod unit has to be expected. To put it differently, this means that the steering angle of the vehicle is smaller and that the turning radius or turning circle for a given displacement path of the tie rod unit increases. By contrast, when choosing a large relationship of the lever arm to the displacement path of the tie rod unit, it is advantageous that a relatively small force on the actuating unit reliably pivots the wheel of the commercial vehicle by means of the large lever length. If, however, the relationship is kept small, this tends to require larger adjusting forces on the actuating unit. Advantageously, corresponding to the requirement on the turning circle of the vehicle and the forces on the actuating unit required by the weight of and the load on the steering arrangement, an optimum relationship of the lever length to the maximum displacement path of the tie rod unit may be chosen.

Further preferably, the active part of the actuating unit has a valve arrangement, by means of which a working fluid can be supplied and discharged, in order to transmit a steering force to the tie rod unit via a piston element, wherein, when the valve arrangement is closed, the tie rod unit is secured against displacement along the transverse axis. Preferably, the valve arrangement comprises bores on the actuating unit, on which preferably tubes or hoses may be attached, which in turn lead to a pump or control unit with respective valves. The most important function of the valve arrangement is the supply and the discharge of working fluid in the cylindrical region of the actuating unit, in which a piston element fixed to the tie rod unit is displaced since different pressures are generated in the working fluid in front of and behind the piston element within the actuating unit. By preventing or blocking the supply or discharge of the working fluid into the actuating unit, it is simultaneously blocked or prevented that the piston element moves within the cylindrical region of the actuating unit and, thus, that the tie rod unit displaces relative to the actuating unit. Advantageously, the active part of the actuating unit thus ensures a reverse lock of the steering arrangement.

Particularly preferably, the damping part of the actuating unit is integrated into the active part and preferably comprises a damping valve arrangement, wherein the damping valve arrangement and/or the valve arrangement of the active part contribute to damping the displacement of the tie rod unit. In order to realize a particularly compact design of the steering arrangement, it may be preferred to integrate the damping part of the actuating unit into the active part and to use the valve arrangement provided already for the active part also for damping vibrations or oscillations occurring on the steering arrangement. In addition to said valve arrangement, it may be further preferred to provide on the actuating unit damping valves connected in parallel, which irrespective of the function of the active part, such as a possible blocking of the working fluid flow when the reverse lock is set, allow for a damping of vibrations or shocks on the steering arrangement. Alternatively preferably, the damping part may also be provided fluid-mechanically separate from the active part, wherein advantageously also various working fluids, such as air or similar compressible media, may be used in order to damp vibrations or shocks.

Preferably, the restoring part of the actuating unit is spatially and functionally separated from the active part and/or the damping part of the actuating unit. The restoring part is spatially separated from the active part or from the damping part of the actuating unit in particular when the restoring part is arranged in a separate section of the actuating unit adjacent to the active part and/or to the damping part, wherein the restoring element preferably provided in the restoring part engages a specifically provided engagement section on the tie rod unit. An advantage of this embodiment is that the restoring part may be maintained and mounted or dismounted without opening or disrupting working fluid circuits possibly provided in the active part and/or the damping part.

Alternatively, in order to achieve a compact design, the restoring part may be integrated into the active part and/or into the damping part.

Further according to the invention is a restoring part, comprising a first cylinder section, a second cylinder section, a third cylinder section, a fourth cylinder section and a restoring element, wherein at least the first three cylinder sections are designed in the shape of hollow cylinders, wherein the third and the fourth cylinder sections and the restoring element are arranged essentially within the first and the second cylinder sections and displaceable along a restoring axis relative to the first and second cylinder sections, wherein the second cylinder section is displaceable along the restoring axis into the first cylinder section, and the fourth cylinder section, is displaceable along the restoring axis into the third cylinder section, wherein the restoring element with a first end thereof rests against a first limit stop of the third cylinder element, and with its opposing second end rests against a second limit stop of the second cylinder element, wherein while or when or after the fourth cylinder element is/has been displaced along the restoring axis in the direction of the first cylinder element, a second limit stop of the fourth cylinder element supports the second limit stop of the second cylinder element against the restoring element, and the third cylinder element rests against a first limit stop of the first cylinder element, wherein while or when or after the fourth cylinder element is/has been displaced along the restoring axis away from the first cylinder element, a first limit stop of the fourth cylinder element displaces the third cylinder element via a first limit stop in the direction of the fourth limit stop, while a second limit stop of the first cylinder element supports the second cylinder element via the first limit stop thereof against the restoring element, wherein the restoring element while or when or after the first cylinder element is/has been displaced relative to the fourth cylinder element along the restoring axis a restoring force is established between the second and the third cylinder elements. Following the common inventive idea of a compact design, it is particularly preferred that the restoring part comprises interleaved cylinder elements, which may be telescoped into each other in a particularly space-saving manner when the spring ranges are sufficiently large. Thus, the restoring part, apart from the preferred integration of the damping part and of the active part into the actuating unit, for example, makes an essential contribution to the compact design of the steering arrangement on the whole. According to the invention, the restoring part takes over to restore the steering arrangement in the straightforward driving direction or neutral position. To this end, there is provided a restoring element, which in the case of a deflection of the steering arrangement from this neutral position is subjected to pressure in the restoring part, wherein a restoring force acts, which seeks to displace the steering arrangement back in the neutral position. Preferably, the first cylinder element is arranged immovably, indirectly or directly relative to the chassis of the commercial vehicle or to the rigid part of a steering axle, while the fourth cylinder element is arranged indisplaceably or immovably relative to the moving parts of the steering arrangement. According to the invention, a steering deflection of the steering arrangement causes the restoring part to be compressed or extended, wherein the first and the fourth cylinder elements carry out a relative movement with respect to each other. Characteristic of the restoring part according to the invention are the compact design and the ability of the restoring element to be subjected only to pressure, both when the restoring part is compressed and when it is extended. Thus, the service life or the number of possible load cycles of the restoring element, such as a spiral spring, can be significantly increased. The compact design results from the arrangement according to the invention of the four cylinder elements and the limit stops provided on the respective cylinder elements. The limit stops are preferably formed as collars protruding inwards or outwards and serve either for supporting the restoring element or for supporting or carrying a corresponding limit stop of a cylinder element, which is to be supported or entrained in one direction. Preferably, the restoring element is pretensioned between the second and the third cylinder elements, also while the steering arrangement is in the neutral position.

Advantageously, the restoring element essentially completely fills the extension or building length along or parallel to the restoring axis occupied by the second cylinder element and the third cylinder element. The building length defined by the second and the third cylinder elements preferably corresponds to the sum of the overall extension of both cylinder elements less the length, along which the second and the third cylinder elements overlap, and less the extension of the second limit stop of the second cylinder element and the extension of the first limit stop of the third cylinder element along the restoring axis. Thus, “essentially” means in this context that from the overall extension of building length occupied by the second and third cylinder elements together, merely the extension of the two outer limit stops is deducted in order to come to the preferred extension of the restoring element. This preferred design of the restoring part may lead to a particularly good space utilization by the restoring element, and in the case of a compact design of the restoring element and, thus, of the steering arrangement, particularly large spring ranges are available.

Preferably, the first collar of the third cylinder comes to rest against the first limit stop of the first cylinder element, while the restoring part is compressed. In order to achieve a compact and, thus, weight-saving design of the restoring part, it is preferred to arrange the first limit stop of the third cylinder element as far away as is possible from the second limit stop of the fourth cylinder element and, thus, to utilize the extension or the available length of the restoring part along the restoring axis essentially completely with the restoring element. Thus, in the case of a comparatively short overall length of the restoring part, a rather large, maximum possible spring range of the restoring element results. Here, the relationship of the maximum possible spring range, i.e. the amount or travel, by which the spring element may be compressed at most, to the overall length of the restoring part in the neutral position is preferably 0.3 to 0.8, particularly preferably 0.4 to 0.7, and most preferably it is about 0.5 to 0.6. The overall length of the restoring part is preferably the distance of the first limit stop of the first cylinder element from the second limit stop of the fourth cylinder element in the neutral position. As a matter of course, the described relationship depends on the geometry of the restoring element, in particular the relationship of the wire thickness of a preferably used spiral spring to the distance of the coils from each other along the restoring axis.

Preferably, the restoring part has a support unit, comprising a first support element and a second support element, wherein the first support element is fixed to the first cylinder element, and the second support element is fixed to the fourth cylinder element, wherein one of the support elements has a recess, into which the respective other support element may be inserted along the restoring axis at least in sections, so that it is prevented that the first cylinder element pivots relative to the fourth cylinder element along the restoring axis. The support unit protects the restoring part preferably against buckling when subjected to pressure along the restoring axis. Preferably, the first support element telescopically engages the second support element, so that transverse to the restoring axis there is a form-fit between the two support elements, which essentially prevents a displacement of the first support element relative to the second support element transverse to the restoring axis. “Essentially” in this context means that within the framework of the clearance due to production there may be smaller displacements also transverse to the restoring axis.

According to the invention, there is provided a steering system combining the features of the above-described steering arrangement and the restoring part, which is also according to the invention. Said steering system has a preferred, compact design, since the compact arrangement of the components of the actuating unit may be combined with a compact restoring part.

Further advantages and features of the present invention become apparent from the following description with reference to the appended Figures. Individual features of the preferred embodiments shown may be combined within the scope of the invention.

### BRIEF DESCRIPTION OF THE DRAWINGS

The Figures show:

FIG. 1 shows a view of a preferred embodiment of the steering arrangement according to the invention in the neutral position,

FIG. 2 shows a preferred embodiment of the steering arrangement according to the invention with joints,

FIG. 3 shows a preferred embodiment of the actuating unit with inserted tie rod unit,

FIG. 4 shows a view of a preferred embodiment of the steering arrangement according to the invention in the neutral position, and

FIG. 5 shows a sectional view of a preferred embodiment of the restoring part according to the invention.

### DETAILED DESCRIPTION OF THE PREFERRED EMBODIMENT

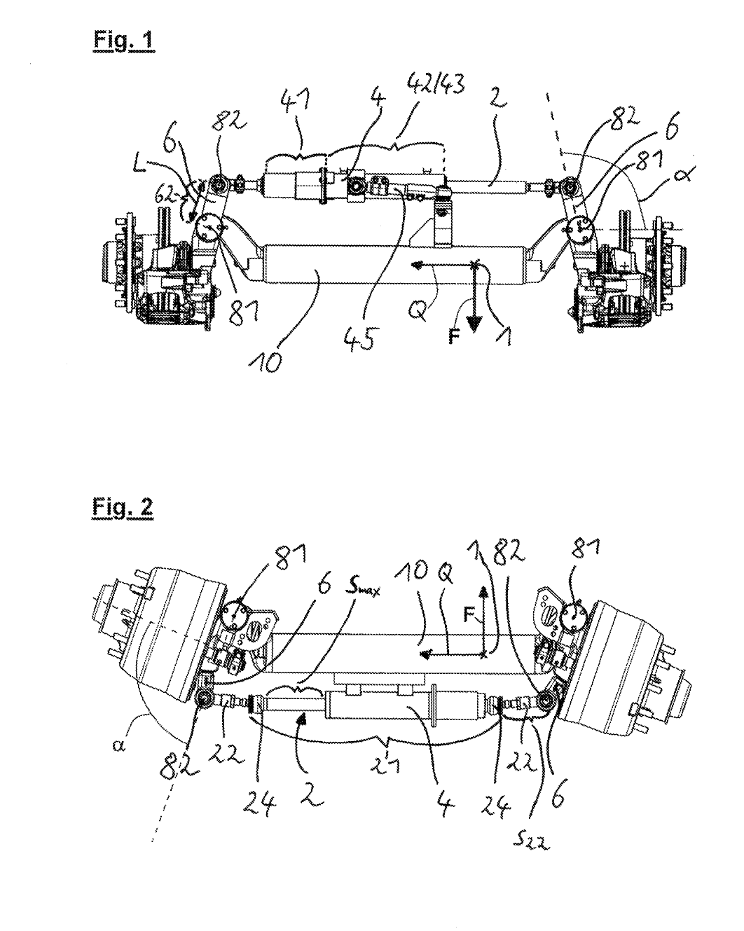

FIG. 1 shows a preferred embodiment of the steering arrangement according to the invention, wherein an actuating unit 4 is indirectly fixed to the rigid axle 10 of a commercial vehicle by means of a fixing element 45. The fixing element 45 secures the actuating unit 4 in particular against displacement relative to a reference system 1 along a transverse axis Q. The actuating unit 4 has a restoring part 41, an active part 42 and a damping part 43, wherein in the preferred embodiment shown the active part 42 and the damping part 43 are designed integrally. Alternatively preferably, the damping part 43 may be designed spatially and functionally separate from the active part 42. Preferably, a tie rod unit 2 passes through the actuating unit 4, wherein the tie rod unit 2 is preferably guided through the actuating unit 4. Preferably, the tie rod unit 2, at the distal ends thereof, directly or indirectly engages a second turning point 82 and is pivotably fixed in said respective point to a respective lever element 6. In the second turning points 82, there are particularly preferably provided ball bearings or bushings, which allow for a slight rotating movement of the tie rod unit 2 relative to the lever element 6. The lever element 6 in turn is fixed to the rigid axle 10 rotatably or pivotably in a first turning point 81 immovable to the reference system 1. Preferably, the lever element 6 has a lever arm 62 and further devices, preferably for rotatably mounting a wheel or a wheel suspension of a commercial vehicle. The steering arrangement shown in the Figure, and in particular the lever element, is designed like a pusher axle known from prior art, wherein the axis of rotation of the wheel to be attached to the lever element 6 is arranged behind the first turning point 81. Furthermore, the embodiment of the steering arrangement according to the invention shown in the Figure is in the neutral position, which particularly preferably is characterized in that the axes of rotation of the wheel suspension preferably attached to the lever element 6 are aligned parallel or collinear to the transverse direction Q of the reference system 1. To put it differently, the steering deflection of the steering arrangement in the neutral position is zero. Particularly preferably, in order to adjust a certain relative steering angle, the straight line running along the lever arm 62 of the lever element 6 is pivoted by an angle α with reference to the transverse direction Q. Relative steering angle in this context means a larger steering angle of the lever element 6 lying inside during cornering, with reference to the curve traveled, in comparison to the lever element 6 lying outside. In the embodiment shown in the Figure, when a left curve is traveled, the wheel suspension shown on the right in the Figure accordingly has a larger steering angle than the left one. The two first turning points 81 and the two second turning points 82 preferably span not a rectangle but a trapezoid, usually also referred to as steering trapezoid. The larger the angle α, the larger the relative steering angle may preferably be set. The lever arm 62 of the lever element 6 preferably has a length L, which is in a preferred relationship to the maximum possible path of displacement sₘₐₓ of the tie rod unit 2 of 0.7-1.3, preferably of 0.85-1.1, and particularly preferably of 0.9-1. Furthermore, the steering arrangement according to the invention, depending on the available building space on the commercial vehicle, seen in the straightforward driving direction F, may be arranged behind the rigid axle 10.

FIG. 2 shows a preferred embodiment of the steering arrangement according to the invention, wherein the tie rod unit 2 particularly preferably has two joints 24, which pivotably connect a first tie rod section 21 to a respective second tie rod section 22, wherein a displacement of the tie rod unit 2 along the transverse direction Q is possible without pivoting or displacing the first tie rod section 21 perpendicular or transverse to the transverse direction Q. Preferably, the actuating unit 4, which guides the first tie rod section 21, can be arranged fixedly and immovably on the rigid axle 10. Preferably, it is possible to avoid fixing the actuating unit 4 in an expensive and time-consuming manner by means of a fixing element 45, as is shown in FIG. 1, and it is possible to choose a more robust design of the steering arrangement. The second tie rod sections 22 have a preferred extension s₂₂, which is in a relationship to the maximum displacement path sₘₐₓ of the tie rod unit 2 or of the first tie rod section 21 of preferably 0.3-1.5, particularly preferably of 0.5-1, and most preferably of 0.7-0.8. The extension s₂₂ of the second tie rod sections 22 is measured in particular from the turning point of the joint 24 up to the second turning point 82. Since the steering arrangement is not in the neutral position, the angle α is measured not from a parallel of the transverse axis Q, but from the axis of rotation of wheels (not shown) preferably mounted on the steering arrangement to the straight line running along the lever arm 6. In the embodiment shown in FIG. 2, the angle α is preferably only slightly larger than 90°.

FIG. 3 shows a detailed view of the tie rod unit 2 already shown in FIG. 2 with a first tie rod section 21, two joints 24 and two second tie rod sections 22. In this embodiment, the actuating unit 4 can be fixed immovably on a rigid axle 10, which is not shown, wherein the two fixing sections 46 may simultaneously contain the supply and discharge channels for the working fluid in of the active part 42 or the damping part 43 of the actuating unit 4. As is shown in the Figure, in the restoring part 41, there is provided a restoring element, wherein the latter is maximally compressed in the shown position of the tie rod unit. In the Figure, the restoring unit 2 is thus maximally deflected to the left relative to the actuating unit 4 or relative to the reference system 1 along the transverse axis Q.

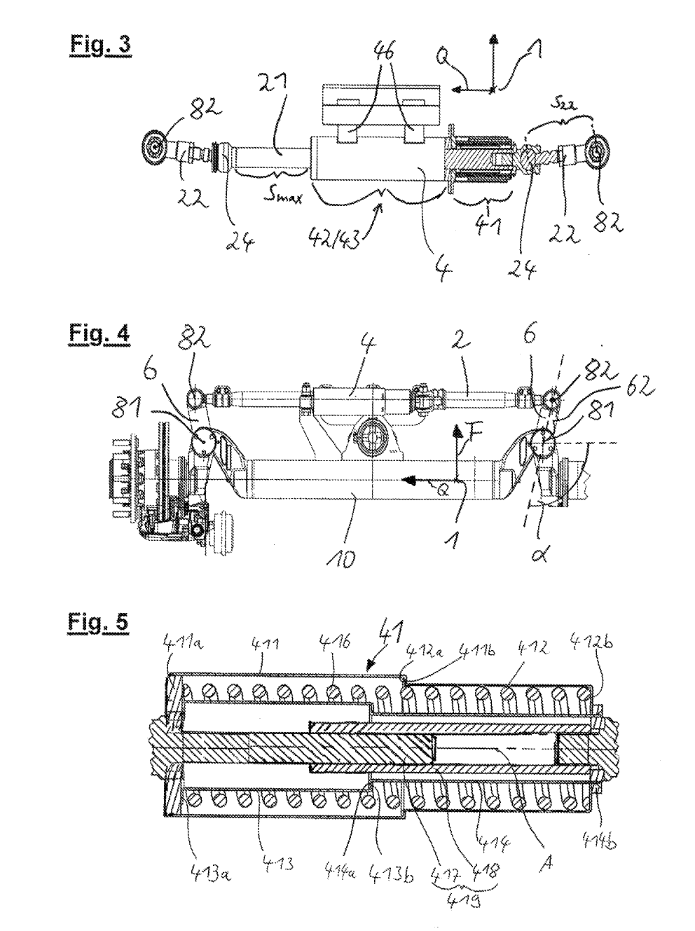

FIG. 4 shows a preferred embodiment of the steering arrangement according to the invention, which is designed as a trailing axle, in the neutral position. The first turning points 81 of the steering arrangement, in the straightforward driving direction F of the commercial vehicle, are preferably arranged in front of the wheel bearings of the wheels, which are not shown, i.e. above said wheel bearings in the Figure, through which bearings the transverse axis Q runs in the shown position. Furthermore, the second turning points 82 in the straightforward driving direction F of the commercial vehicle are arranged in front of the first turning points 81, in the Figure accordingly above the first turning points 81. The above-described definition of the angle α, in the neutral position facing from a parallel to the transverse axis Q outwards in the direction of the wheels (not shown) of the commercial vehicle, opposite the straightforward driving direction F up to the straight line running along the lever arm 6, results for the present embodiment in that the lever arms 6 describe an open V. The longer one of the parallels of the steering trapezoid is accordingly limited by the second turning points 82.

As a matter of course, the measured angles are defined between the projections of the spatially arranged straight line and points on the viewer plane of the respective Figure. FIG. 5 shows a sectional view of a preferred embodiment of the restoring part 41 according to the invention. The restoring part comprises four cylinder elements 411, 412, 413 and 414, which preferably are designed in the shape of hollow cylinders or bushes and which preferably have inner and outer diameters differing from those of the respective other cylinder elements. Preferably, the second cylinder element 412 may be inserted or moved at least in sections into the first cylinder element 411, and the fourth cylinder element 414 may be inserted or moved at least in sections into the third cylinder element 413. Further preferably, the third and the fourth cylinder elements 413, 414 are at least in certain sections arranged in the hollow space spanned by the first and the second cylinder elements 411, 412. The first cylinder element 411 has a first limit stop 411a, which preferably is designed as a bottom or end plate. The first limit stop 411a of the first cylinder element 411 with its outwards facing surface is connected to further parts of the actuating unit 4 (not shown) or to rigid sections of the commercial vehicle. Furthermore, on the first limit stop 411a of the first cylinder element 411 there is preferably fixed the first support element 417 of the support unit 419, by a screwed joint (shown) or by a welded joint, for example. The second cylinder element 412 has a second limit stop 412b, which preferably is designed as a cap with a recess, wherein through the recess the fourth cylinder element 414 passes and may slide relative to the second cylinder element 412. When the restoring part 41 is compressed, the second limit stop 412b of the second cylinder element 412 rests against a second limit stop 414b of the fourth cylinder element 414, so that the end of the restoring element 416 shown at the right-hand side of the Figure is displaced towards the left. The left end of the restoring element 416 rests against the first limit stop 413a of the third cylinder element 413, which preferably rests against the first limit stop 411a of the first cylinder element 411. By compressing the restoring element 416 a restoring force is established by the restoring element between the second limit stop 412b of the second cylinder element 412 and the first limit stop 413a of the third cylinder element 413, and thus indirectly between the fourth and the first cylinder elements 414, 411. When the restoring element 41 is extended or when the distance between the fourth cylinder element 414 and the first cylinder element 411 is enlarged, the fourth cylinder element 414 slides towards the right in the recess in the second limit stop 412b of the second cylinder element 412. While the first limit stop 414a of the fourth cylinder element 414 supports the second limit stop 413b of the third cylinder element 413 and, thus, pulls the third cylinder element 413 towards the right, the second cylinder element 412 via the first limit stop 412a thereof, which engages the second limit stop 411b of the first cylinder element 411, is secured against displacement to the right in the Figure, relative to the first cylinder element 411. By displacing the third cylinder element 413 along the restoring axis A relative to the second cylinder element 412, the restoring element 416 is compressed between the first limit stop 413a of the third cylinder element 413 and the second limit stop 412b of the second cylinder element 412 and exerts a restoring force on both limit stops 413a and 412b, which causes the restoring part 41 to seek its neutral position, in which the restoring element 416 has its largest extension along the restoring axis A. As a matter of course, the restoring part 41 shown in FIG. 5 may be used in the embodiment of the actuating unit 4 shown in FIG. 3, for example, wherein either the first limit stop 411a of the first cylinder element 411 or the second limit stop 414b of the fourth cylinder element 414 is fixed to the tie rod unit, and the respective other limit stop is connected to the housing of the actuating unit 4. Also the embodiments of the steering arrangement according to the invention shown in FIGS. 1 and 2, may be enriched by a compact design by installing the restoring part 41 shown in FIG. 5.

List of reference signs

| | |
|---|---|
| 1 | reference system |
| 2 | tie rod unit |
| 4 | actuating unit |
| 6 | lever element |
| 10 | rigid axle |
| 21 | first tie rod unit |
| 22 | second tie rod unit |
| 24 | joint |
| 41 | restoring part |
| 42 | active part |
| 43 | damping part |
| 45 | fixing element |
| 46 | fixing section |
| 62 | lever arm |
| 81 | first turning point |
| 82 | second turning point |
| 411 | first cylinder element |
| 411a | first limit stop |
| 411b | second limit stop |
| 412 | second cylinder element |
| 412a | first limit stop |
| 412b | second limit stop |
| 413 | third cylinder element |
| 413a | first limit stop |
| 413b | second limit stop |
| 414 | fourth cylinder element |
| 414a | first limit stop |
| 414b | second limit stop |
| 416 | restoring element |
| 417 | first support element |
| 418 | second support element |
| 419 | support unit |
| A | restoring axis |
| α | angle |
| F | straightforward driving direction |
| L | length |
| Q | transverse axis |
| sₘₐₓ | maximum displacement path |
| s₂₂ | extension of the second tie rod sections |

1.-15. (canceled)

16. A steering arrangement, comprising:
a tie rod unit;
an actuating unit; and
a lever element;
wherein the lever element is fixed in a pivotable manner at a first turning point immovably disposed in a reference system;
wherein the actuating unit has a restoring part, an active part and a damping part and is secured against displacement along a transverse axis relative to the reference system;
wherein at least one of the restoring part, the active part and the damping part exerts a force on the tie rod unit to at least one of displace the tie rod unit along the transverse axis and to secure it against displacement along the transverse axis;
wherein the tie rod unit is fixed in a pivotable manner at a second turning point on the lever element so that a displacement of the tie rod unit along the transverse axis leads to a pivoting movement of the lever element about the first turning point; and
wherein the damping part transmits a damping force to the tie rod unit.

17. The steering arrangement of claim 16, wherein the tie rod unit passes through the actuating unit, and wherein the tie rod unit at respective distal ends thereof is fixed at second turning points at respective lever elements.

18. The steering arrangement of claim 16, wherein the actuating unit is pivotably mounted relative to the reference system, so that displacement components of the second turning point are compensated perpendicular to the transverse direction by pivoting the actuating unit.

19. The steering arrangement of claim 16, wherein the actuating unit has a fixing element fixing the actuating unit perpendicular to the transverse direction and movably relative to the reference system.

20. The steering arrangement of claim 16, wherein the tie rod unit comprises a joint fixing a first tie rod section and a second tie rod section pivotably to each other, wherein the first tie rod section is guided in the actuating unit and secured against displacement perpendicular to the transverse direction, and wherein the actuating unit is fixed immovably and secured against pivoting relative to the reference system.

21. The steering arrangement of claim 16, wherein the lever element has a lever arm extending between the first and second turning points,
wherein in a neutral position of the lever arm a straight line running along the lever arm is directed pivoted at an angle to the transverse direction of the reference system, and wherein the angle is preferably larger than 90°.

22. The steering arrangement of claim 16, wherein the first turning point is spaced apart from the second turning point by a lever length, wherein the tie rod unit is displaceable within a maximum displacement path along the transverse axis, and wherein the relationship of the lever length to the maximum displacement path is in a range of about 0.7 to about 1.3.

23. The steering arrangement of claim 22, wherein the relationship of the lever length to the maximum displacement path is in the range of 0.85 to 1.1.

24. The steering arrangement of claim 23, wherein the relationship of the lever length to the maximum displacement path is in the range of 0.9 to 1.

25. The steering arrangement of claim 16, wherein the active part of the actuating unit has a valve arrangement, configured to supply and discharge a working fluid, in order to transmit a steering force to the tie rod unit via a piston element, wherein the tie rod unit is secured against displacement along the transverse axis when the valve arrangement is closed.

26. The steering arrangement of claim 25, wherein the damping part is integrated into the active part and comprises a damping valve arrangement, and wherein the damping valve arrangement and/or the valve arrangement of the active part contribute(s) to damping the displacement of the tie rod unit.

27. The steering arrangement of claim 16, wherein the restoring part is spatially and functionally separated from the active part and/or the damping part of the actuating unit.

28. A restoring part, comprising:
a first cylinder element;
a second cylinder element;
a third cylinder element;
a fourth cylinder element; and
a restoring element;
wherein at least the first, second and third cylinder elements comprise hollow cylinders;
wherein the third and the fourth cylinder elements and the restoring part are at least partially arranged within the first and the second cylinder elements and are displaceable along a restoring axis relative to the first and second cylinder elements;
wherein the second cylinder section is displaceable along the restoring axis into the first cylinder element, and the fourth cylinder element is displaceable along the restoring axis into the third cylinder element;
wherein a first end of the restoring element rests against a first limit stop of the third cylinder element, and with a second, opposing end thereof rests against a second limit stop of the second cylinder element;
wherein while or when or after the fourth cylinder element is/has been displaced along the restoring axis in the direction of the first cylinder element, a second limit stop of the fourth cylinder element supports the second limit stop of the second cylinder element against the restoring element, and the third cylinder element rests against a first limit stop of the first cylinder element;
wherein while or when or after the fourth cylinder element is/has been displaced along the restoring axis away from the first cylinder element, a first limit stop of the fourth cylinder element displaces the third cylinder element via a first limit stop in the direction of the fourth cylinder element, while a second limit stop of the first cylinder element via the first limit stop thereof supports the second cylinder element against the restoring element;
wherein, while or when or after the first cylinder element is/has been displaced relative to the fourth cylinder element along the restoring axis, the restoring element establishes a restoring force between the second cylinder element and the third cylinder element; and
wherein the relationship of the maximum spring range of the restoring element to the overall length of the restoring part is about 0.3 to about 0.8 in a neutral position.

29. The restoring part of claim 28, wherein the restoring element substantially completely fills the extension occupied by the second cylinder element and by the third cylinder element along the restoring axis.

30. The restoring part of claim 28, wherein a first collar of the third cylinder comes to rest against the first limit stop of the first cylinder element, while the restoring part is compressed.

31. The restoring part of claim 28, further comprising:
a support unit that includes a first support element and a second support element;
wherein the first support element is fixed to the first cylinder element, and the second support element is fixed to the fourth cylinder element; and
wherein one of the support elements has a recess into which the respective other support element are inserted at least in sections along the restoring axis, such that the first cylinder element is prevented from pivoting relative to the fourth cylinder element along the restoring axis.

32. A steering system, comprising a steering arrangement according to claim 16.

33. A steering system, comprising a restoring part according to claim 28.
